(19) United States
(12) Patent Application Publication
(10) Pub. No.: US 2026/0175785 A1
(43) Pub. Date: Jun. 25, 2026

(54) SWINGABLE VEHICLE ACCESSORY MOUNT ASSEMBLY

(71) Applicant: NRTV COLLAB INC., Orange, CA (US)

(72) Inventors: Luke Benjamin Wronski, Costa Mesa, CA (US); Eric Reed Ichiro Pyle, Orange, CA (US)

(21) Appl. No.: 19/427,332

(22) Filed: Dec. 19, 2025

Related U.S. Application Data
(60) Provisional application No. 63/790,541, filed on Apr. 17, 2025.
(60) Provisional application No. 63/736,506, filed on Dec. 19, 2024.

(51) Int. Cl. B60R 9/06; B60R 9/10

(52) U.S. Cl. CPC B60R 9/06; B60R 9/10

(57) ABSTRACT

A swingable accessory mount assembly for a vehicle includes a pivoting arm assembly having a first arm configured to be attached to a hitch receiver of the vehicle and a second arm pivotally coupled to the first arm to rotate about a pivot axis between a closed position and an open position. The pivoting arm assembly is selectively attachable to the hitch receiver of the vehicle in each of a first orientation, in which the second arm opens toward a first lateral side of the vehicle, and a second orientation, in which the second arm opens towards a second lateral side of the vehicle. The pivoting arm assembly is rotated about an axis of the hitch receiver between the first orientation and the second orientation. An accessory mount extension is attachable to the second arm in each of the first orientation and the second orientation.

### PRIORITY AND INCORPORATION BY REFERENCE

This application is related to and claims the benefit of U.S. Provisional Application Nos. 63/790,541, filed April 17, 2025, and 63/736,506, filed December 19, 2024, each pending, each titled SWINGABLE VEHICLE ACCESSORY MOUNT ASSEMBLY, the entireties of which are incorporated by reference herein and made a part of the present disclosure. Any and all applications for which a foreign or domestic priority claim is identified in connection with the present application are hereby incorporated by reference herein and made a part of the present disclosure.

### BACKGROUND

### Field

The present disclosure relates to vehicle accessories. In particular, the present disclosure relates to hitch-mounted and/or swingable accessory carriers.

### Description of Related Art

Many types of hitch-mounted and/or swingable accessory carriers exist. However, a need exists for arrangements that improve on one or more aspects of the prior art hitch-mounted and/or swingable accessory carriers, or at least provide the public with a useful choice.

### SUMMARY

The systems, methods and devices described herein have innovative aspects, no single one of which is indispensable or solely responsible for their desirable attributes. Without limiting the scope of the claims, some of the advantageous features will now be summarized.

An aspect of the present disclosure involves a swingable accessory mount assembly for a vehicle. The swingable accessory mount assembly includes a pivoting arm assembly having a first arm configured to be attached to a hitch receiver of the vehicle, the hitch receiver defining a hitch axis. The swingable accessory mount assembly also includes a second arm pivotally coupled to the first arm to rotate relative to the first arm about a pivot axis between a closed position and an open position. The second arm has a first surface and a second surface opposite the first surface. Each of the first surface and the second surface is oriented perpendicular to the hitch axis. The pivoting arm assembly is configured to be selectively attachable to the hitch receiver of the vehicle in each one of a first orientation in which the second arm opens toward a first lateral side of the vehicle and a second orientation in which the second arm opens towards a second lateral side of the vehicle. The pivoting arm assembly is rotated about the hitch axis between the first orientation and the second orientation. An accessory mount extension is attachable to the second arm in each of the first orientation and the second orientation of the pivoting arm assembly. The accessory mount extension is supported on the first surface in the first orientation and is supported on the second surface in the second orientation.

In some configurations, the first surface faces vertically upward in the first orientation and the second surface faces vertically upward in the second orientation.

In some configurations, the accessory mount extension is attached to the second arm by at least a first fastener and a second fastener. A first fastener axis of the first fastener is oriented perpendicular to a second fastener axis of the second fastener.

In some configurations, the first arm comprises a receiver mount configured to be received by the hitch receiver of the vehicle and the second arm comprises a hitch adapter configured to receive a hitch-mountable accessory. The receiver mount and the hitch adapter are axially aligned.

In some configurations, the accessory mount extension is located on an opposite lateral side of the hitch adapter from the pivot axis.

In some configurations, the swingable accessory mount assembly includes a lock configured to secure the second arm in the closed position relative to the first arm. The lock is located on the opposite lateral side of the hitch adapter from the pivot axis.

In some configurations, the accessory mount extension is attached to the second arm by at least a first fastener having a first fastener axis and a second fastener having a second fastener axis. At least a portion of the lock is positioned between the first fastener axis and the second fastener axis.

In some configurations, the first fastener axis is oriented perpendicular to the second fastener axis.

In some configurations, the swingable accessory mount assembly includes a lock pin assembly located on a same lateral side of the hitch adapter as the pivot axis.

In some configurations, the lock comprises a latch hook and a staple having an opening that receives the latch hook. A position of the staple is adjustable to facilitate alignment with the latch hook.

In some configurations, the accessory mount extension is located on a same lateral side of the hitch adapter as the pivot axis.

In some configurations, the accessory mount extension comprises a vertical support post comprising a first section and a second section oriented at an angle relative to the first section.

In some configurations, the second section is located above the first section, and the first section is angled such that an upper end of the first section is located closer to a lateral centerline of the vehicle than a lower end of the first section.

In some configurations, the accessory mount extension includes a vertical support post having a lower end that is positioned alongside a lateral end of the first arm between the first surface and the second surface.

In some configurations, the accessory mount extension is configured to support one or more accessory wings, a license plate holder, and/or a fold out table.

In some configurations, the second arm includes a hitch adapter configured to receive a hitch-mountable accessory. A vertical bike rack having a receiver mount is supported by the hitch adapter. A retention arrangement secures the vertical bike rack to the hitch adapter. The retention arrangement is accessible from an end of the receiver mount located in the hitch adapter when the second arm is in the open position.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a perspective view of a swingable vehicle accessory mount assembly or swing-out having certain features, aspects, and advantages of the present disclosure.

FIG. 2 illustrates the swing-out of FIG. 1 mounted to a vehicle and illustrating available clearance for a rear trunk lid or rear gate of a vehicle.

FIG. 3 is a rear view of the swing-out of FIG. 1 separate from the vehicle.

FIG. 4 is a side view of the swing-out of FIG. 1.

FIG. 5 is a perspective view of the swing-out of FIG. 1 in an open position with the upright support separated from the swingable arm.

FIG. 6 is a perspective view of the upright support separated from the swingable arm.

FIG. 7 is a rear view of a portion of the swing-out of FIG. 1.

FIG. 8 is a sectional view of the swing-out of FIG. 1 taken along line 126-126 of FIG. 3.

FIG. 9 is a sectional view of the swing-out of FIG. 1 taken along line 127-127 of FIG. 3.

FIG. 10 is a perspective view of a receiving assembly and a portion of the swingable arm of the swing-out of FIG. 1.

FIG. 11 is a perspective view of the receiving assembly of FIG. 10.

FIG. 12 is a perspective view of a pivot assembly of the swing-out of FIG. 1.

FIG. 13 is a perspective view of the swing-out of FIG. 1 in a reversed and upside-down orientation relative to the orientation of FIGS. 1-12 and the upright support repositioned to extend upwardly from the bottom surface in the orientation of FIGS. 1-12, which is the top surface in FIG. 13.

FIG. 14A is a rear view of the swing-out of FIG. 1 illustrating a first relative location of a lock pin assembly.

FIG. 14B is a rear view of an alternative version of the swing-out illustrating a second relative location of the lock pin assembly that is closer to the pivot assembly relative to the location of FIGS. 1-14A.

FIG. 15 is perspective view of an alternative version of the swing-out in which the upright support is secured to the swingable arm between the pivot assembly and the receiving assembly and the receiver mount.

FIG. 16 is a perspective view of the receiving assembly and the receiver mount of the swing-out of FIG. 15.

FIG. 17A is a perspective view of the swing-out of FIG. 15 with the accessory wings removed from the upright support.

FIG. 17B is a perspective view of the swing-out of FIG. 15 in a reversed and upside-down orientation relative to the orientation of FIGS. 15-17A and the upright support repositioned to extend upwardly from the bottom surface in the orientation of FIGS. 15-17A, which is the top surface in FIG. 17B.

FIG. 18 is a perspective view of another alternative version of the swing-out having an alternative version of the upright support.

FIG. 19 is a perspective view of the swing-out of FIG. 18 with the upright support separated from the swingable arm.

FIG. 20A is a rear view of the upright support.

FIG. 20B is a rear view of the bottom attachment portion of the upright support identified by the circle 20B in FIG. 20A.

FIG. 21A is a side view of the upright support.

FIG. 21B is a side view of the bottom attachment portion of the upright support identified by the circle 21B in FIG. 21A.

FIG. 22 is a perspective view of a vertical bicycle rack attached to a swing-out.

FIG. 23 is a sectional view of a retention arrangement for a mounting portion of the bicycle rack configured to engage a hitch receiver of a vehicle.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extend beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

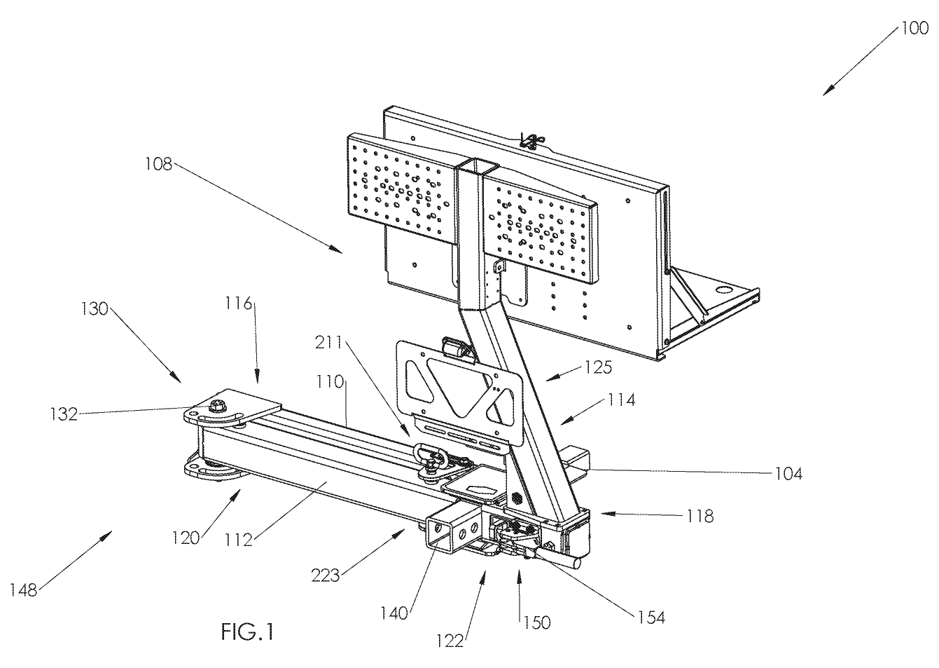

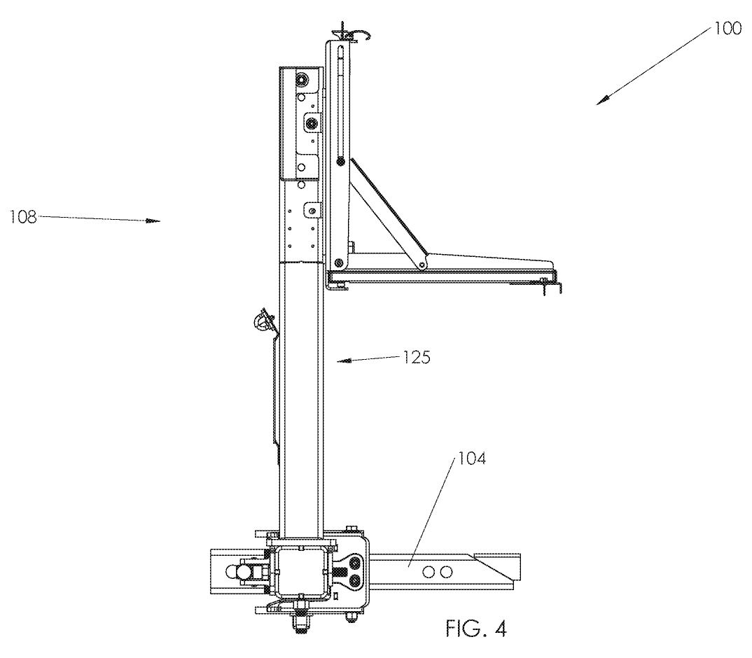

FIGS. 1-13 illustrate an implementation of a swingable accessory mount assembly 100 alone or mounted to a vehicle 102. In the illustrated arrangement, the swingable accessory mount assembly 100 is configured for mounting to a hitch receiver of the vehicle 102. However, in other implementations, the swingable accessory mount assembly 100 can be otherwise mounted or supported relative to the vehicle 102. In the illustrated arrangement, the swingable accessory mount assembly 100 includes a receiver mount 104 configured for mounting to a hitch receiver of the vehicle 102.

In the illustrated arrangement, the swingable accessory mount assembly 100 includes a pivoting arm assembly that has a first arm 110 and a second arm 112. The first arm 110 has a first end 114 and a second end 116. The first end 114 is attached to the receiver mount 104. The first arm 110 extends laterally from the receiver mount 104 to the second end 116. Accordingly, the first arm 110 preferably does not extend across the entire width of the vehicle 102. Preferably, the first arm 110 is located substantially on one half of the vehicle 102 in a width direction.

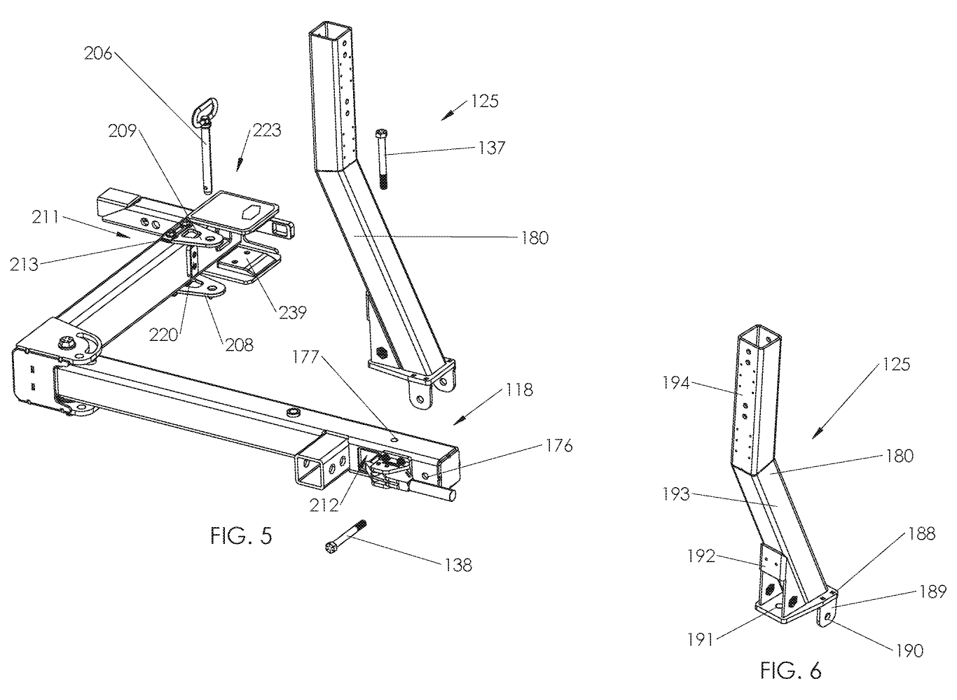

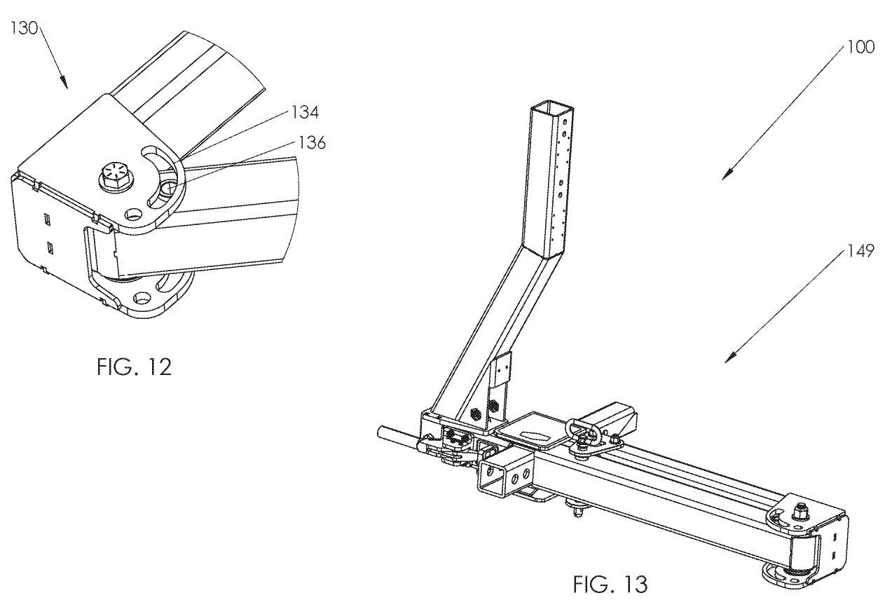

The second arm 112 has a first end 120 and a second end 122. The first end 120 is pivotally attached to or near the second end 116 of the first arm 110. The second arm 112 is movable between a closed position and an open position relative to the first arm 110. In particular, a pivot assembly 130 provides for swinging or pivotal movement of the second arm 112 relative to the first arm 110. In the illustrated arrangement, the pivot assembly 130 provides for rotational movement about a single pivot axis 132. However, in other arrangements, the pivot assembly 130 can provide for more complex movement, such as via a linkage arrangement. In addition, the pivot assembly 130 provides one or a plurality of lock positions for the open position of the second arm 112. A lock pin (e.g., 206—FIG. 5) can pass through the one or plurality of openings 134 and into an aperture 136 of the second arm 112 (FIG. 12). Preferably, the second arm 112 does not extend an entire width of the vehicle. In at least some implementations, the second arm 112 has a length that is about 100-125% of the first arm 110.

With continued reference to the illustrated arrangement in FIG. 1, the swingable accessory mount assembly 100 can additionally include an accessory mount extension 125. The accessory mount extension 125 generally extends upward away from the first arm 110 and the second arm 112 of the swingable accessory mount assembly 100 and is configured to support various accessories 108.

In the illustrated arrangement, the accessory mount extension 125 is removably attached to a mount region 118. The mount region 118 can be defined in whole or in part by the second end 122 of the second arm 112. In the illustrated arrangement, the mount region 118 is defined by a portion of the second end 122 located on an opposite side of the hitch adapter 140 from the pivot assembly 130 such that the mount region 118 extends past the hitch adapter 140. The mount region 118 can also support a portion or an entirety of a lock closed arrangement or lock 150, which can include a latch 154 and an aperture 212 for the passage of a staple 156.

In the illustrated arrangement, the swingable accessory mount assembly 100 also includes a receiving assembly 223. The receiving assembly 223 is configured to receive a portion of the second arm 112 that supports or is adjacent to the hitch adapter 140 when the swingable accessory mount assembly 100 is in a closed position. The lock closed arrangement 150 can be configured to secure the second arm 112 in the closed position by the latch 154 engaging the staple 156.

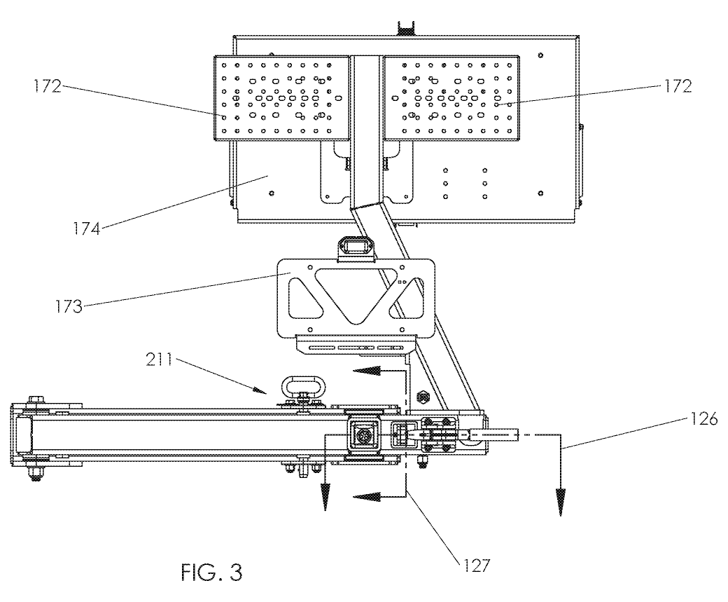

With reference to FIG. 1 and FIG. 3, the accessory mount extension 125 can be configured to receive various accessories, such as accessory wings 172, a license plate holder 173 or a fold out table 174. As will be appreciated by one skilled in the art, the accessory mount extension 125 can also receive various other accessories including a bicycle rack, a tire rack, a ski rack, water jugs, gasoline jugs or various other types of accessories. Preferably, the accessories are removably fastened to the accessory mount extension 125. In other embodiments, accessories may be welded or otherwise permanently attached to the accessory mount extension 125. In some embodiments, wiring for a light of the license plate holder 173 can include a magnetic wire connection having a first portion carried by the first arm 110 and a second portion carried by the second arm 112, which allows the wiring to extend from a location near the receiver mount 104 to the license plate holder 173 without passing through or along the entire length of the first arm 110 and the second arm 112.

With reference to FIG. 1 and FIG. 13, the illustrated arrangement of the accessory mount extension 125 can be selectively mountable to more than one location of the mount region 118 of the swingable accessory mount assembly 100. In some configurations, the accessory mount extension 125 can be selectively mounted in at least two positions, which can be opposite one another. In the illustrated arrangement, the accessory mount assembly 100 can be mounted on an upper surface or a lower surface of the second arm 112, wherein the upper and lower surfaces are relative to the swingable accessory mount assembly 100 being in one position, such as that shown in FIG. 1. As shown in the illustrated arrangement in FIG. 1, the swingable accessory mount assembly 100 is arranged in a driver side swing arrangement 148 such that the pivot assembly 130 is generally located on the driver side of a vehicle and the accessory mount extension 125 extends vertically upward. In contrast, in FIG. 13 the swingable accessory mount assembly 100 is configured in a passenger side swing arrangement 149 such that the pivot assembly 130 is located on the passenger side of a vehicle and the accessory mount extension 125 also extends upwards. The swingable accessory mount assembly 100 is turned upside-down to move between the driver side swing arrangement 148 and the passenger side swing arrangement 149 and rotated about a fore-aft axis that passes through the receiver mount 104. The removable nature of the accessory mount extension 125 and the generally symmetric nature of the swingable accessory mount assembly 100 allows for, in some arrangements, the accessory mount extension 125 to be used in both positions as illustrated by FIG. 1 and FIG. 13. This arrangement can be advantageous as a single embodiment of the accessory mount extension 125 can be used for multiple arrangements.

With reference to FIG. 5 and FIG. 6, the illustrated arrangement depicts an accessory mount extension 125 configured in a generally cantilevered structure supported at a single end relative to the second arm 112. The accessory mount extension 125 comprises a base plate 188 supporting a section 193 further supporting a section 194. In the illustrated arrangement, section 193 is oriented at an oblique angle relative to the second arm 112, such that the section 194 can be desirably positioned generally over the hitch adapter 140 in a cantilevered manner. The section 193 can be further supported by a gusset 192. As will be appreciated by one skilled in the art, section 194 and section 193 can be constructed of a single curved assembly to achieve a similar cantilevered nature.

With continued reference to FIG. 5 and FIG. 6, the illustrated arrangement of the accessory mount extension 125 can further comprise a mounting hole 191 in the base plate 188 and can include side tabs 189, each with a mounting hole 190. The illustrated arrangement allows the accessory mount extension 125 to be removably attached to the mount region 118 of the swingable accessory mount assembly 100. Furthermore, in the illustrated arrangement, a first bolt 137 and a second bolt 138 can be used to attach the accessory mount extension 125 to the swingable accessory mount assembly 100. Advantageously, the first bolt 137 and the second bolt 138 can be arranged in offset directions or axes (e.g., perpendicular directions) so as to provide strength and resistance to movement in all directions of forces and movements.

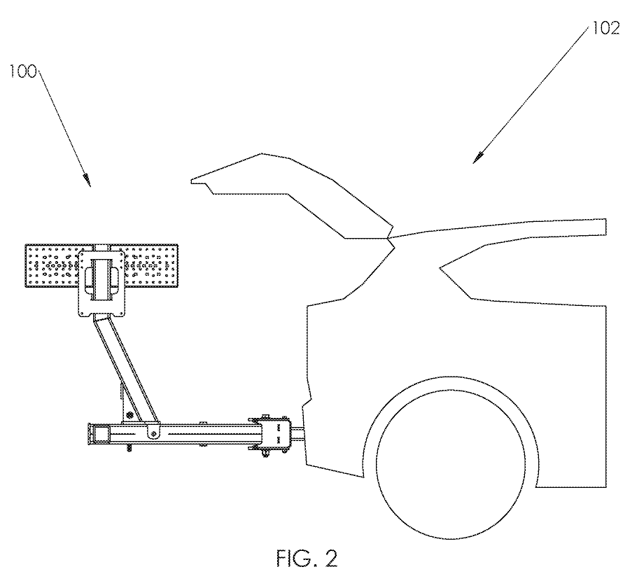

With reference to FIG. 2, the illustrated arrangement of the angle of the section 193 of the accessory mount extension 125 can be configured to provide additional clearance of a vehicle door or lift gate or other rear door style.

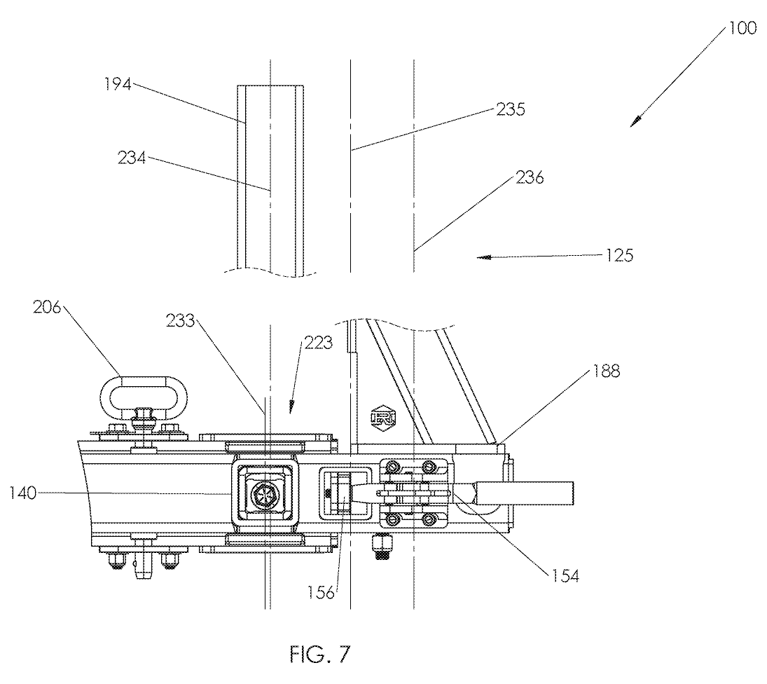

With reference to FIG. 7, the illustrated arrangement of the swingable accessory mount assembly 100 includes a reference line 233 that passes vertically through the center of the hitch adapter 140. The illustrated arrangement further includes a reference line 234 that passes vertically through the section 194 of the accessory mount extension 125. The section 194 of the accessory mount extension 125 can be positioned such that a reference line 234 of section 194 is positioned coincident with or close to the reference line 233 of the hitch adapter 140. In some arrangements, the relative position of the reference line 234 and the reference line 233 can be between 0 and 5mm or between 0 and 10mm or between 0 and 50 millimeters or between 0 and 100mm. The relative arrangement of the reference line 234 and the reference line 233 can provide advantages when accessories are mounted to the accessory mount extension 125 such that any carried load can be generally centralized over the receiver mount 104.

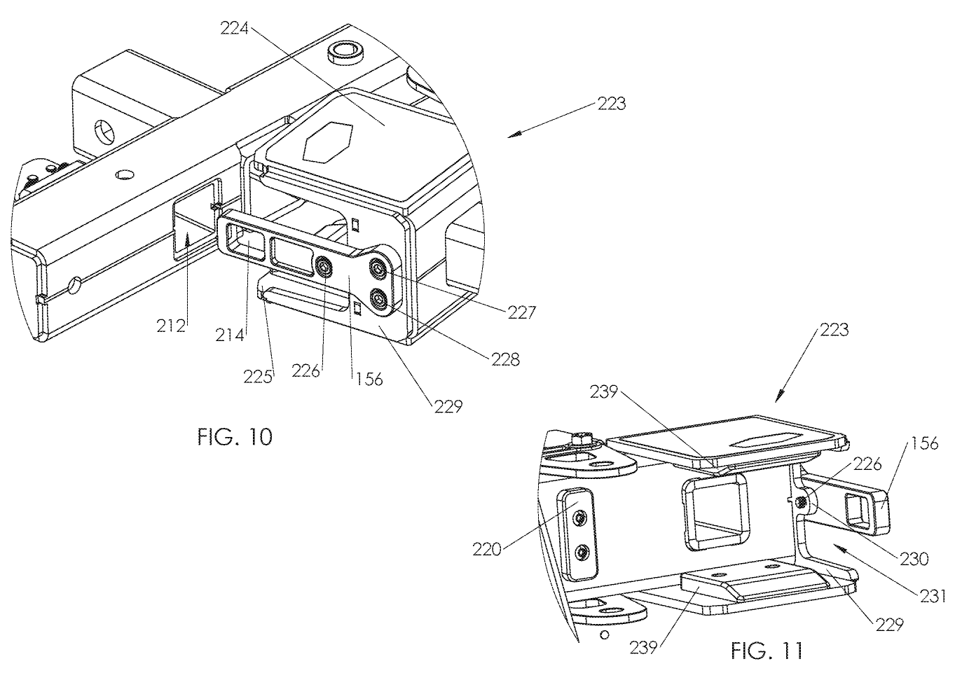

With reference to FIG. 5, FIG. 6, FIG. 10, and FIG. 11, the illustrated arrangement of the swingable accessory mount assembly 100 includes the receiving assembly 223. The receiving assembly 223 can include a first bounding plate 224 and a second bounding plate 225. The first bounding plate 224 and the second bounding plate 225 are configured to support and receive at least a portion of the second arm 112 and/or hitch adapter 140 when the accessory mount assembly is in a lock closed position, such as by the lock closed arrangement 150. In some embodiments, an upper one of the first bounding plate 224 and the second bounding plate 225, depending on the orientation of the swingable accessory mount assembly 100, can serve as a footstep and can include a gripped portion for foot traction.

In the illustrated arrangement, the receiving assembly 223 can also include an end plate 229 (FIG. 10), which extends between and connects the first bounding plate 224 and the second bounding plate 225 while still providing an opening 231 to allow the second arm 112 to rest substantially parallel to the first arm 110 when the swingable accessory mount assembly 100 is in the lock closed position. The end plate 229 can also provide mounting provisions to attach the staple 156 with multiple fasteners. In some embodiments, the multiple fasteners can include a first bolt 226, a second bolt 228, and a third bolt 227. The end plate 229 can also include a bolt provision 230 that extends into the opening 231. In the illustrated arrangement, the bolt provision 230 can allow for a wider bolt pattern to attach the staple 156 to the swingable accessory mount assembly 100. In other arrangements, a bolt pattern such as a two bolt pattern, a four bolt pattern, or a single bolt pattern can be used, alone or together with additional supports (e.g., a pin and hole arrangement between staple 156 and the end plate 229).

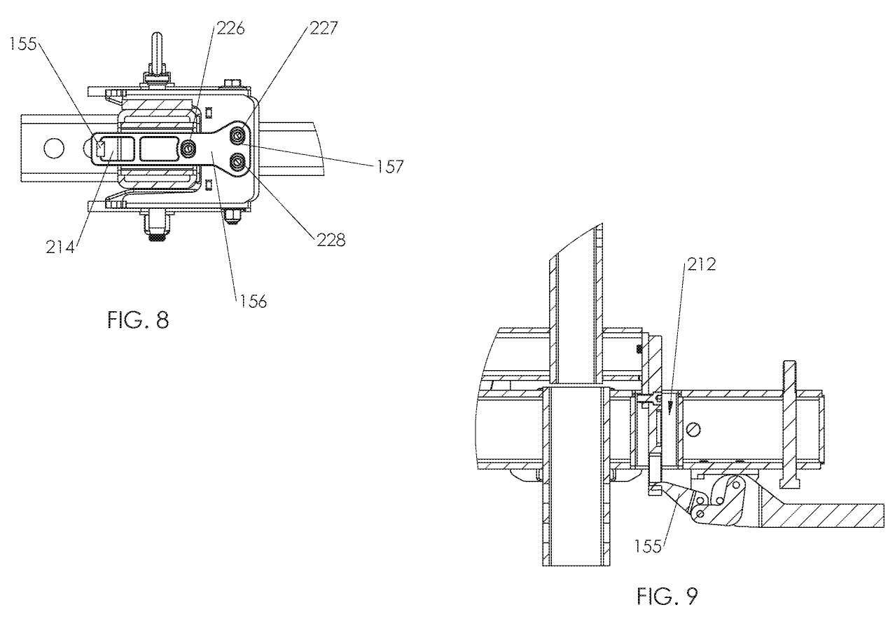

FIG. 8 and FIG. 9 illustrate the section views as noted by line 126 and line 127 of FIG. 3. In the illustrated arrangement of FIG. 8 and FIG. 9, the staple 156 can comprise apertures 157, each configured to receive a respective one of the first bolt 226, the second bolt 228, and the third bolt 227. The apertures 157 can comprise an elongated shape to allow adjustment of the staple 156 relative to a latch hook 155 illustrated in FIG. 9. In some embodiments manufacturing tolerances can be difficult to hold. The illustrated arrangement can provide ease of adjustment and tuning of the operation of the latch 154 such that the opening 214 of the staple 156 can be centrally aligned with the latch hook 155 in a vertical direction.

With reference to FIG. 5 and FIG. 11, the illustrated arrangement of the receiving assembly 223 can also include slide block 239 for ease of entry and wear resistance of the second arm 112 and hitch adapter 140. In some embodiments the slide block 239 can be made of a low friction material.

With reference to FIG. 5, the swingable accessory mount assembly 100 can also include a lock pin assembly 211. The lock pin assembly 211 can include a first lock pin tab 208 and a second lock pin tab 209. In some configurations, each of the first lock pin tab 208 and the second lock pin tab 209 is removably attached to the first arm 110. The lock pin assembly 211 can also include a bumper 220. The bumper 220 can provide preload for the operation of the latch 154 or additional vibration reduction. In some embodiments, the first lock pin tab 208 and the second lock pin tab 209 can have different characteristics. For example, one of the first lock pin tab 208 and the second lock pin tab 209 can be configured to allow the lock pin 206 to pass through more easily than the other of the first lock pin tab 208 and the second lock pin tab 209, which is configured to impose a retention force on the lock pin 206. In some embodiments, the first lock pin tab 208 and the second lock pin tab 209 can be reversed and attached in opposing locations depending on the mount orientation of the swingable accessory mount assembly 100 relative to a vehicle 102. The lock pin assembly 211 can also include a removably detachable pin tether 213 which provides a mounting location for a tether to attach the lock pin 206.

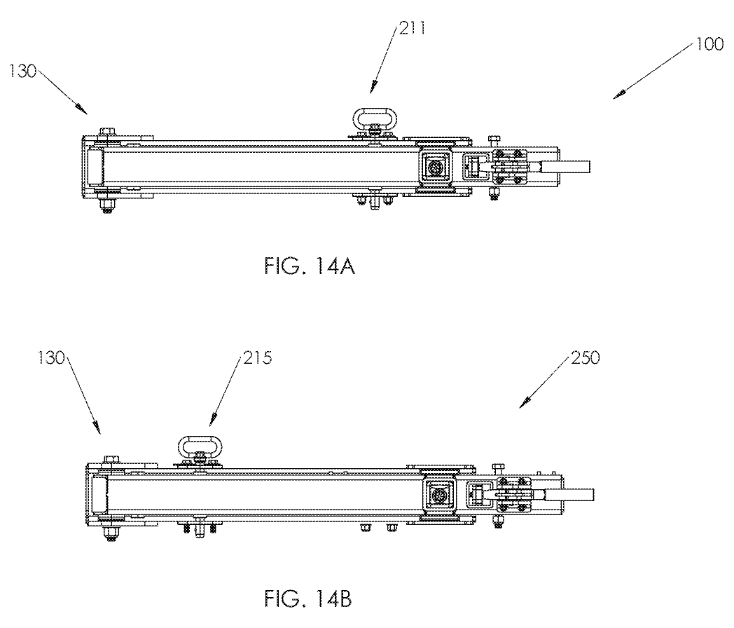

With reference to FIG. 14A and FIG. 14B, the illustrated arrangement of the lock pin assembly 211 can be mounted in various locations on the first arm 110 and second arm 112 of the swingable accessory mount assembly 100. FIG. 14B illustrates an arrangement of an accessory mount assembly 250 with a lock pin assembly 215 located closer to pivot assembly 130 relative to the location of the pivot assembly 130 in FIG. 14A. In other arrangements, the lock pin assembly 211 can be mounted to locations of the first arm 110 and the second arm 112 other than those shown in FIGS. 14A and 14B.

With reference to FIG. 5 and FIG. 10, the illustrated arrangement of the mount region 118 can include a mounting hole 176 and a mounting hole 177 configured to receive the first bolt 137 and the second bolt 138 for attachment of the accessory mount extension 125. The mount region 118 can also include mounting provisions for the latch 154. Furthermore, the mount region 118 can include the aperture 212 configured to allow the staple 156 to pass through the second arm 112 to engage with the latch 154. In the illustrated arrangement, the mount region 118 extends past the hitch adapter 140 to provide mounting space for the above-mentioned components. In some arrangements the mount region 118 can range from 0mm – 40mm, or 0mm – 120mm, or 0mm – 200mm, or 0mm – 300mm from the hitch adapter 140. In the illustrated arrangement, the structural shape of the mount region 118 is substantially similar to the structural shape of the second arm 112. However, as one skilled in the art will appreciate, the mount region 118 can be made with a different structural shape.

With reference to FIG. 7, in the illustrated arrangement of the mount region 118 includes a reference line 235 on an edge of the base plate 188 of the accessory mount extension 125. In the illustrated arrangement the reference line 235 is offset from the reference line 234. The offset between reference line 234 and the reference line 235 represents a cantilevered nature of the accessory mount extension 125. The offset between reference line 234 and reference line 235 provides advantages including allowing the section 194 of the accessory mount extension 125 to remain generally centralized over the reference line 233 while still allowing the second arm 112 to pass into the receiving assembly 223. The illustrated offset can allow continued foot access to the receiving assembly 223 in both the driver side swing arrangement 148 and the passenger side swing arrangement 149.

With continued reference to FIG. 7, the illustrated arrangement of the swingable accessory mount assembly 100 includes a reference line 236 that passes vertically through the approximate center of the latch 154. Reference line 236 is generally located inline with the center of the base plate 188 of the accessory mount extension 125. Furthermore, reference line 236 is generally located a distance away from reference line 235 in the direction away from the hitch adapter 140.

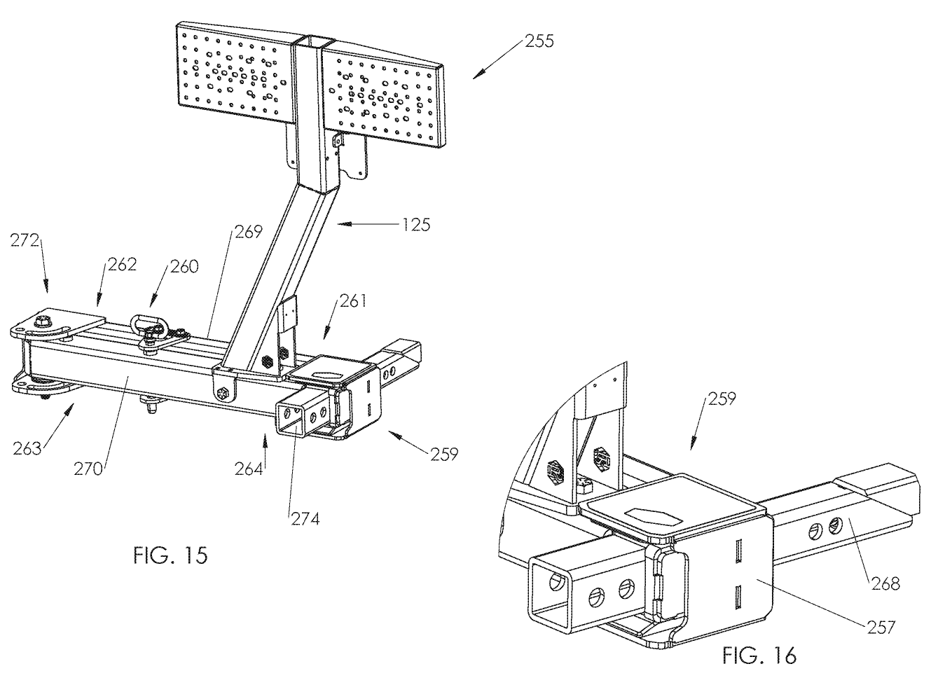

FIGS. 15-17B illustrate another implementation of an accessory mount assembly 255. In the illustrated arrangement, the accessory mount assembly 255 is substantially similar to the illustrated arrangement of FIG. 1. The accessory mount assembly 255 includes a receiver mount 268 and a hitch adapter 274. In the illustrated arrangement, the accessory mount assembly 255 has a first arm 269 and a second arm 270. The first arm 269 has a first end 261 and a second end 262. The first end 261 is attached to the receiver mount 268. The first arm 269 extends laterally from the receiver mount 268 to the second end 262. The second arm 270 has a first end 263 and a second end 264. The first end 263 is pivotally attached to or near the second end 262 of the first arm 269. The second arm 270 is movable between a closed position and an open position relative to the first arm 269. A pivot assembly 272 provides for swinging or pivotal movement of the second arm 270 relative to the first arm 269.

With continued reference to FIG. 15-17B, the illustrated arrangement includes a receiving assembly 259. Differing from the illustrated arrangement of FIG. 1, the receiving assembly 259 includes an end plate 257 which generally closes off the area defined by the receiving assembly 259. Furthermore, the accessory mount assembly 255 omits a latch as described in prior arrangements. In the illustrated arrangement the first arm 269 is held parallel to the second arm 270 went in a closed position by a lock pin 260.

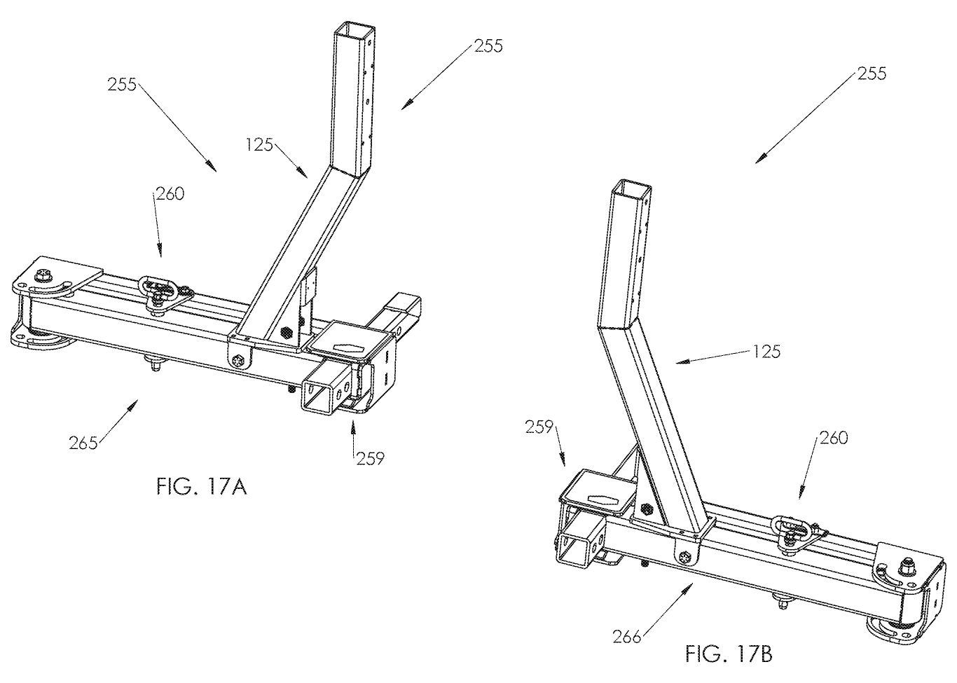

In the illustrated arrangement, the accessory mount assembly 255 can also include accessory mount extension 125 removably attached to the second arm 270. Similar again to previous illustrated arrangements, accessory mount assembly 255 may be configured in a driver side swing arrangement 265 as illustrated in FIG. 17A or in a passenger side swing arrangement 266 as illustrated in FIG. 17B. The accessory mount extension 125 can be mounted on different sides of the second arm 270 to allow the accessory mount extension 125 to extend generally vertically. The accessory mount assembly 255 is configured in either arrangement described above and illustrated in FIG. 17A and FIG. 17B.

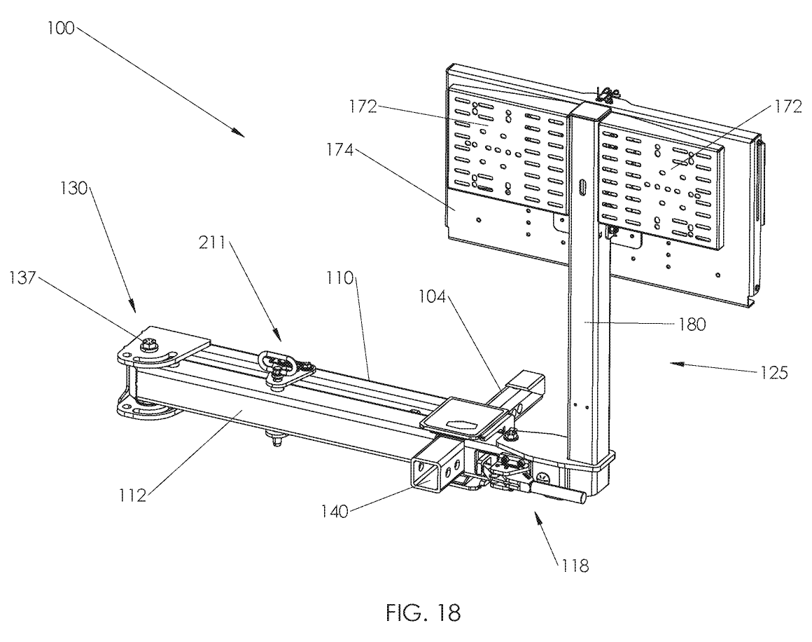

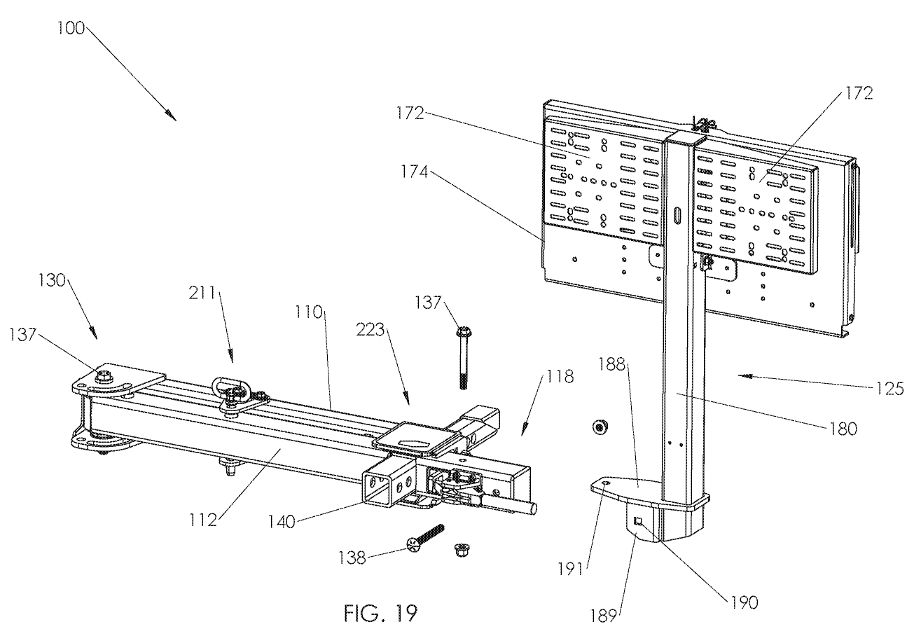

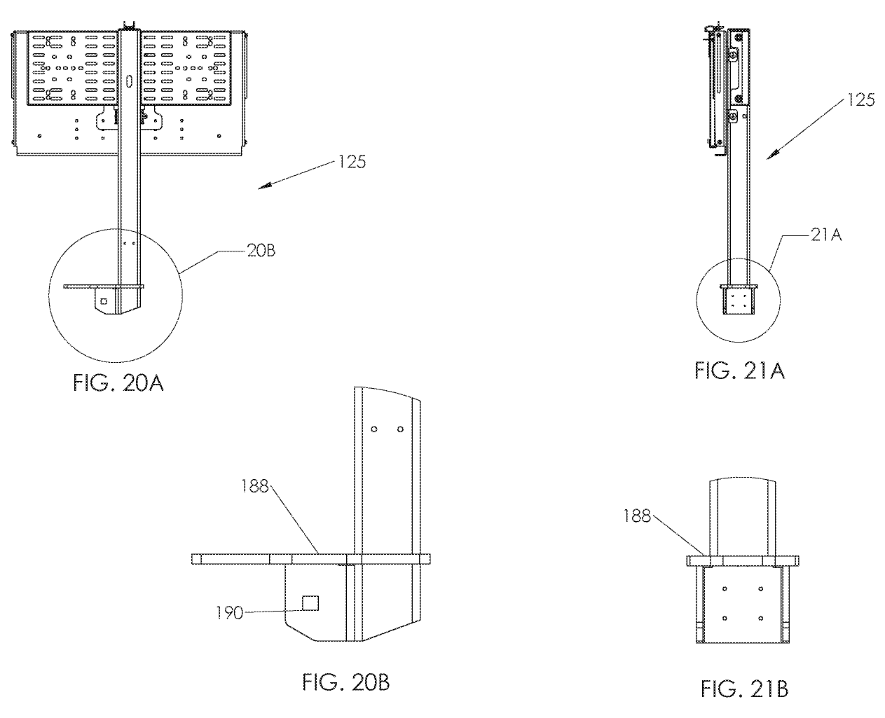

FIGS. 18-21B illustrate an alternative swingable accessory mount assembly 100. In the illustrated arrangement, the accessory mount extension 125 is an alternative to the accessory mount extensions 125 of FIGS. 1-17B. Other portions or components of the swingable accessory mount assembly 100 can be the same as or similar to the corresponding portions or components of the swingable accessory mount assembly 100 of FIGS. 1-17B. In the prior accessory mount extension 125, a lower end of the lower section 193 (see FIG. 6) terminates at the base plate 188. In the accessory mount extension 125 of FIGS. 18-21B, the vertical support post 180 extends below the base plate 188. A lower end of the vertical support post 180 can be angled or rounded with a shorter side of the vertical support post 180 located opposite the end of the second arm 112. Such an arrangement allows the gusset 192 of the prior versions to be omitted, while providing suitable strength and stability to the vertical support post 180.

In addition, the side tabs 189 can be integrated into a C-shaped connection member comprising side wall portions 189 that are operably equivalent to the side tabs 189 of the prior versions connected by an end wall 179 positioned adjacent the vertical support post 180. In some configurations, the end wall 179 and the vertical support post 180 can be secured to one another in a first manner, such as by rivets received within openings shown in FIGS. 21A and 21B, prior to a second connection, which can be a welded connection between the end wall 179 and the vertical support post 180. The accessory mount extension 125 can be secured to the mount region 118 in the same or a similar manner as the other versions described herein.

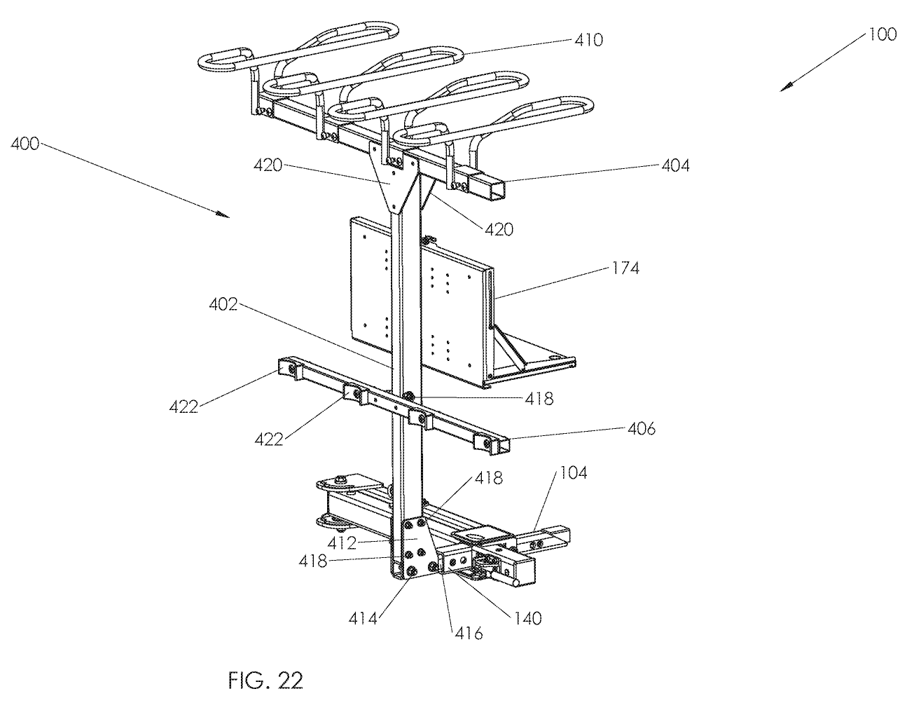

FIG. 22 illustrates a bicycle rack 400 secured to the swingable accessory mount assembly 100. In the illustrated arrangement, the bicycle rack 400 is a vertical bicycle rack configured to hold the bicycle(s) in a vertical, substantially vertical, or tilted orientation. The bicycle rack 400 includes a frame, which in the illustrated arrangement includes several frame members, such as a main vertical frame member 402, an upper horizontal frame member 404, and a lower horizontal frame member 406. The upper horizontal frame member 404 supports one or more wheel-receiving members 410, which can also be referred to as wheel trays. The one or more wheel-receiving members 410 are configured to receive a first wheel of a bicycle to be supported by the bicycle rack 400. The main vertical frame member 402 can be secured by a pair of plates 412 and bolts 414 to a horizontal receiver mount 416. The plates 412 can be secured to the main vertical frame member 402 by additional bolts 418, which can be smaller in diameter and greater in number than the bolts 414. For example, two bolts 414 and four bolts 418 can be provided. Similarly, the upper horizontal frame member 404 can be secured to the main vertical frame member 402 by a pair of plates 420 and suitable bolts or other fasteners. The lower horizontal frame member 406 can support wheel blocks 422, against which a second wheel of the bicycle can rest and, if desired, be secured, such as by a strap.

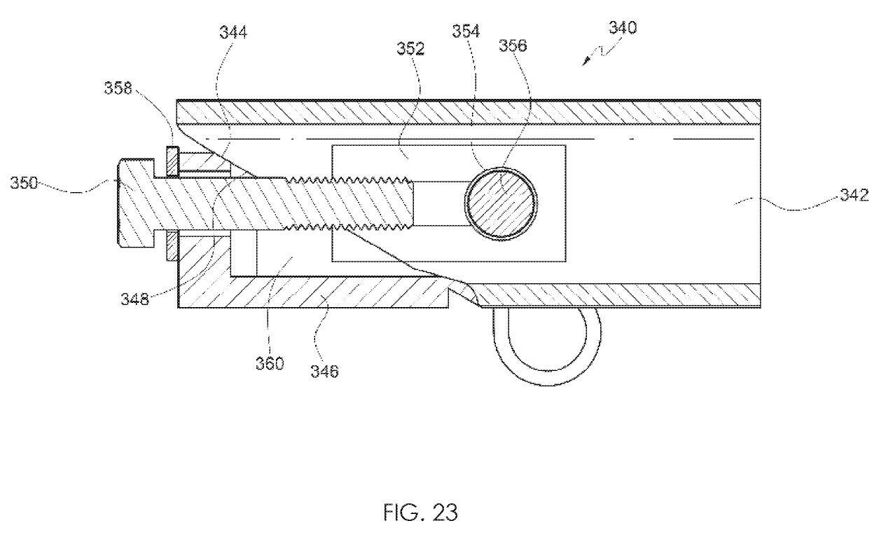

With additional reference to FIG. 23, the bicycle rack 400 is secured to the hitch adapter 140 of the swingable accessory mount assembly 100 by a retention arrangement 340. The retention arrangement 340 is configured to reduce or eliminate wobbling of the bicycle rack 400 relative to the swingable accessory mount assembly 100. Additional details of the retention arrangement 340 can be found in Applicant’s U.S. Patent Publication No. 2023/0331171, titled BICYCLE RACK, the entirety of which is incorporated by reference herein. In the illustrated arrangement, the retention arrangement 340 is accessible from an end of the horizontal receiver mount 416 that is opposite the end coupled to the main vertical frame member 402 and which is inaccessible or is more difficult to access when the bicycle rack 400 is mounted directly to a vehicle hitch. However, when mounted to the swingable accessory mount assembly 100, which can be opened, the retention arrangement 340 is easily accessible in the open orientation of the swingable accessory mount assembly 100. Accordingly, with such an arrangement, the main vertical frame member 402 can be secured to the horizontal receiver mount 416 by the bolts 414, which block access to the interior of the horizontal receiver mount 416 from the end of the horizontal receiver mount 416 that is exposed from the receiver mount 104. A bolted connection is cheaper than a welded connection, which can reduce the cost of the bicycle rack 400. The bolted connection is facilitated by the combined assembly of the bicycle rack 400 and the swingable accessory mount assembly 100. If access from the exposed end of the horizontal receiver mount 416 is desired, a welded connection between the main vertical frame member 402 and the horizontal receiver mount 416 could be employed.

As noted above, the bicycle rack 400 is secured to the hitch adapter 140 of the swingable accessory mount assembly 100 (or to the hitch receiver of the vehicle) by the retention arrangement 340. The hitch adapter 140 includes an outer wall defining an interior space. The retention arrangement 340 includes a hitch insert 342 configured to be inserted into the interior space of the hitch adapter 140. The hitch insert 342 includes a first angled surface 344. A wedge block 346 includes a second angled surface 348.

The retention arrangement 340 also includes a bolt 350 and a nut 352. The nut 352 includes a through-hole 354 configured to receive a hitch receiver pin 356 to secure the nut 352 relative to the hitch adapter 140. In use, the bolt 350 is engaged with the nut 352 and the second angled surface 348 of the wedge block 346 contacts the first angled surface 344 of the hitch insert 342. The bolt 350 applies a force to the wedge block 346 through a washer 358 to move the wedge block 346 relative to the hitch insert 342 with the first angled surface 344 sliding along the second angled surface 348 such that opposing surfaces of the hitch insert 342 and the wedge block 346 are forced against the opposing sides of the outer wall of the hitch adapter 140 to secure the hitch insert 342 to the hitch receiver.

If desired, a spherical washer set could be interposed between a head of the bolt 350 and the wedge block 346. The spherical washer set allows an angle of the bolt 350 to vary somewhat relative to the wedge block 346 to accommodate the sliding movement of the wedge block 346 relative to the hitch insert 342, which rotates the nut 352 about an axis of the hitch receiver pin 356.

In some configurations, the hitch insert 342 extends from a first end of the hitch adapter 140 towards the bicycle rack 100 or other apparatus and the bolt 350 is accessible from a second end of the hitch adapter 140 opposite the first end. A longitudinal axis of the bolt 350 can be aligned with a longitudinal axis of the hitch receiver. In some configurations, a longitudinal axis of the bolt 350 is perpendicular with a longitudinal axis of the hitch receiver pin 356. In some configurations, the wedge block 346 comprises a recess 360 configured to accommodate a portion of the nut 322.

### Conclusion

It should be emphasized that many variations and modifications can be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. A swingable accessory mount assembly for a vehicle, comprising:
a pivoting arm assembly, comprising:
a first arm configured to be attached to a hitch receiver of the vehicle, the hitch receiver defining a hitch axis;
a second arm pivotally coupled to the first arm to rotate relative to the first arm about a pivot axis between a closed position and an open position, the second arm having a first surface and a second surface opposite the first surface, each of the first surface and the second surface oriented perpendicular to the hitch axis;
wherein the pivoting arm assembly is configured to be selectively attachable to the hitch receiver of the vehicle in each one of a first orientation in which the second arm opens toward a first lateral side of the vehicle and a second orientation in which the second arm opens towards a second lateral side of the vehicle, the pivoting arm assembly being rotated about the hitch axis between the first orientation and the second orientation;
an accessory mount extension that is attachable to the second arm in each of the first orientation and the second orientation of the pivoting arm assembly, the accessory mount extension being supported on the first surface in the first orientation and being supported on the second surface in the second orientation.

2. The swingable accessory mount assembly of claim 1, wherein the first surface faces vertically upward in the first orientation and the second surface faces vertically upward in the second orientation.

3. The swingable accessory mount assembly of claim 1, wherein the accessory mount extension is attached to the second arm by at least a first fastener and a second fastener, wherein a first fastener axis of the first fastener is oriented perpendicular to a second fastener axis of the second fastener.

4. The swingable accessory mount assembly of claim 1, wherein the first arm comprises a receiver mount configured to be received by the hitch receiver of the vehicle, wherein the second arm comprises a hitch adapter configured to receive a hitch-mountable accessory, the receiver mount and the hitch adapter being axially aligned.

5. The swingable accessory mount assembly of claim 4, wherein the accessory mount extension is located on an opposite lateral side of the hitch adapter from the pivot axis.

6. The swingable accessory mount assembly of claim 5, further comprising a lock configured to secure the second arm in the closed position relative to the first arm, the lock being located on the opposite lateral side of the hitch adapter from the pivot axis.

7. The swingable accessory mount assembly of claim 6, wherein the accessory mount extension is attached to the second arm by at least a first fastener having a first fastener axis and a second fastener having a second fastener axis, wherein at least a portion of the lock is positioned between the first fastener axis and the second fastener axis.

8. The swingable accessory mount assembly of claim 7, wherein the first fastener axis is oriented perpendicular to the second fastener axis.

9. The swingable accessory mount assembly of claim 6, further comprising a lock pin assembly located on a same lateral side of the hitch adapter as the pivot axis.

10. The swingable accessory mount assembly of claim 6, wherein the lock comprises a latch hook and a staple having an opening that receives the latch hook, wherein a position of the staple is adjustable to facilitate alignment with the latch hook.

11. The swingable accessory mount assembly of claim 4, wherein the accessory mount extension is located on a same lateral side of the hitch adapter as the pivot axis.

12. The swingable accessory mount assembly of claim 1, wherein the accessory mount extension comprises a vertical support post comprising a first section and a second section oriented at an angle relative to the first section.

13. The swingable accessory mount assembly of claim 12, wherein the second section is located above the first section, and wherein the first section is angled such that an upper end of the first section is located closer to a lateral centerline of the vehicle than a lower end of the first section.

14. The swingable accessory mount assembly of claim 1, wherein the accessory mount extension comprises a vertical support post having a lower end that is positioned alongside a lateral end of the first arm between the first surface and the second surface.

15. The swingable accessory mount assembly of claim 1, wherein the accessory mount extension is configured to support one or more accessory wings, a license plate holder, and/or a fold out table.

16. The swingable accessory mount assembly of claim 1, wherein the second arm comprises a hitch adapter configured to receive a hitch-mountable accessory, a vertical bike rack having a receiver mount that is supported by the hitch adapter, a retention arrangement that secures the vertical bike rack to the hitch adapter, the retention arrangement being accessible from an end of the receiver mount located in the hitch adapter when the second arm is in the open position.
